(19) United States
(12) Patent Application Publication
(10) Pub. No.: US 2018/0001340 A1
(43) Pub. Date: Jan. 4, 2018

(54) METHOD FOR FORMING A COMPACT FILM OF PARTICLES ON THE SURFACE OF A CARRIER LIQUID

(71) Applicant: COMMISSARIAT A L'ENERGIE ATOMIQUE ET AUX ENERGIE ALTERNATIVES, Paris (FR)

(72) Inventor: Olivier DELLEA, La Talaudiere (FR)

(73) Assignee: COMMISSARIAT A L'ENERGIE ATOMIQUE ET AUX ENERGIE ALTERNATIVES, Paris (FR)

(21) Appl. No.: 15/543,692

(22) PCT Filed: Jan. 14, 2016
(86) PCT No.: PCT/EP2016/050602

§ 371 Date: Jul. 14, 2017

(30) Foreign Application Priority Data
Jan. 16, 2015 (FR) 15 50337

(51) Int. Cl. B05D 1/20

(52) U.S. Cl. CPC B05D 1/20

(57) ABSTRACT

A method for forming a compact film of particles on a surface of a carrier liquid, including: positioning at least one particle support in the carrier liquid, the support including at least one solidified portion in which the particles are trapped and that is made from at least one cooled liquid, melting of the support in the carrier liquid resulting in release of the particles on the surface of the carrier liquid; and organizing the released particles to obtain the compact film of particles on the surface of the carrier liquid.

### TECHNICAL FIELD

The invention relates to the field of methods for formation of a compact film of particles at the surface of a carrier liquid, where the compact film obtained is generally intended to be deposited on a substrate, preferably in motion.

More precisely, the invention relates to the formation of a compact film of particles, also known as an ordered particle film, preferably of the monolayer type and whose particle size may be between a few nanometres and several hundred micrometres. The particles, preferably non-spherical in shape, may be, for example, particles of silica, glass fibres, carbon nanotubes or gallium nitride fibres. In this respect, it should be noted that recent studies have shown that the use of non-spherical particles/colloids represents a highly promising path for the design of materials with novel properties. Colloids may occur in longilinear forms such as fibres, threads, tubes or rods or in more complex shapes such as polygons, tetrapods, cubes, prisms etc.

The invention relates to the formation of simple compact films, or to the formation of structured compact films, the purpose of this structuring being to give the film a shape, in order, for example, to incorporate other particles and/or objects into it. Another possibility involves providing zones free of particles surrounded by the film which remains ordered. In the case of objects being incorporated into the film, this involves in particular the fabrication of devices which have a hybrid character such as sensors, for example. For indication purposes, a hybrid device by definition brings objects which have various functions together on a given substrate, for example, electronics, optics, electro-optics, piezo-electrical, thermoelectrical and mechanical objects etc.

The objects to be incorporated into the particle film are, for example:

active electronic components, such as transistors, microprocessors, integrated circuits etc.;

passive electronic components, such as resistances, capacitances, diodes, photodiodes, coils, conductive paths solder-preforms etc.;

optical components such as lenses, micro-lenses, diffraction networks, filters etc.;

batteries, micro-batteries, photo-detectors, solar cells, RFID systems etc.;

nano- or micro-metric aggregates or particles, active or passive, for example of the oxide, polymer, metal, semiconductor or Janus type (particles which have two faces with different properties or of different character), nanotubes etc.

Nevertheless, the invention relates more to the formation of simple compact films rather than to the formation of structured compact films.

More generally the invention has applications in numerous fields such as mechanical engineering, fuel cells, optics, photonics, polymer coatings, micro-chips,

MEMs, organic and photovoltaic electronics, heat exchangers, sensors such as chemical sensors, tribology etc.

### THE STATE OF THE PRIOR ART

There are many techniques known for the formation and deposition of compact films of particles onto a substrate where the latter may or may not be in motion and may be rigid or flexible in character.

In general, an accumulation and transfer zone which is fed with particles is envisaged, where the particles float on a carrier liquid contained in this same zone. The particles that are ordered in the transfer zone and which form a monolayer of particles, known as a thin film, are pushed on by the arrival of other particles, as well as by the flow of the carrier liquid, towards an outlet from this zone through which they reach the substrate. They are then deposited on the substrate in motion. In order to achieve this, a capillary bridge usually provides the link between the substrate and the carrier liquid contained in the accumulation and transfer zone.

With the installation in normal operation the particles are kept ordered in the accumulation and transfer zone, in particular by the pressure exerted upstream by the moving particles which are destined to subsequently reach this transfer zone. The cohesion of the ordering of the particles is furthermore achieved through weak forces of the capillary or electrostatic type. When the particle transfer zone is linked in the upstream direction to an inclined ramp on which the particles coming from a dispensing device are moving, it is these particles on the inclined ramp that are the very same particles that exert a pressure on the particles contained in the transfer zone and which therefore, in association with the proximity capillary forces, maintain the ordering of the particles in this zone up until deposition onto the substrate, by capillarity or direct contact.

In this respect, it should be noted that the technique for ordering of the particles by compression is in particular known from the document by Locio Isa et al., “Particle Lithography from Colloidal Self-Assembly at Liquid_Liquid Interfaces”, acsnano, VOL. 4□NO. 10□5665-5670□2010, from the document by Markus Retsch, “Fabrication of Large-Area, Transferable Colloidal Monolayers Utilizing Self-Assembly at the Air/Water Interface”, Macromol. Chem. Phys. 2009, 210, 230-241, or from the document by Maria Bardosova, “The Langmuir-Blodgett Approach to Making Colloidal Photonic Crystals from Silica Spheres”, Adv. Mater. 2010, 22, 3104-3124. As for the technique of compression assisted by an inclined ramp, this is described more precisely in document CA 2 695 449. With this specific technique, it is the kinetic energy associated with the particles in motion on the ramp which allows the particles to become ordered automatically on this ramp when they come up against the leading edge of the particles, which is itself also located on the inclined ramp. The ordering is therefore established on the ramp, and then preserved when the ordered particles enter the transfer zone, as a result of the continuous feed of particles that impact the leading edge.

The kinetic energy required for self-ordering of the particles is here supplied by the inclined ramp which transports the carrier liquid and the particles. In this respect, it should be noted that the particles are in general in suspension in a solvent placed within the dispensing device which, for example, takes the form of a nozzle. This dispensing device is arranged to deliver the particles to the surface of the carrier liquid at a zone which forms a reservoir, located upstream of the inclined ramp and which is connected to the inlet of the latter.

Alternatively, particles in suspension in a solvent may be dispensed directly onto the surface of the carrier liquid using a pipette or a peristaltic pump. The particles dispersed at the surface of the carrier liquid are then ordered using barriers or similar elements. This brings them close together in order to obtain the compact film of particles to be subsequently deposited onto the substrate.

Nevertheless, these techniques for dispensing particles suffer from several drawbacks, listed below, which are moreover exacerbated when the particles have a non-spherical shape.

First of all, if the particles contained in the dispensing device undergo rapid sedimentation it may prove difficult or even impossible to obtain uniform and homogeneous dispensation onto the carrier liquid. Sedimentation of this type can even accidentally lead to the obstruction of the end of the dispensing device, such as the disposable tip of a pipette. Moreover, particles can be deposited inside the dispensation device, giving a false estimate of the actual quantity of particles introduced at the surface of the carrier liquid.

Furthermore, in the specific case of a pipette, there are multiple factors which influence the amount of solvent/particles actually drawn up and dispensed. These are, for example, the temperature and pressure of the outside air, the density of the solvent, the dead volume etc. All these factors may then influence the amount drawn up/dispensed, which has an adverse effect on the precision and repeatability of the operations.

### DESCRIPTION OF THE INVENTION

The purpose of the invention is therefore to at least partially provide a response to the drawbacks identified above. In order to do this the aim of the invention first of all is a method for forming a compact film of particles at the surface of a carrier liquid and which comprises the following steps:

setting up at least one particles support in said carrier liquid, where said support comprises at least one solidified portion in which the particles are trapped and which is made from at least one cooled liquid, where said support, on melting into said carrier liquid, leads to particles being released at the surface of this carrier liquid; and

ordering of the particles released in order to obtain said compact film of particles at the surface of the carrier liquid.

The invention is therefore remarkable in that it breaks drastically from conventional techniques for dispensing particles at the surface of a carrier liquid. The technique that is specific to the invention exhibits the advantage of not being liable to the sedimentation risks stated above, or to the risks associated with obstruction of a pipette-type dispensing device, which is no longer necessary.

The precision and the repeatability of the operations are advantageously improved by this, since the quantity of particles released during the melting of the support is precise, and there is no risk of losses. Moreover, the technique proposed by the invention is capable of being applied in an analogous manner whatever the particle shape and size may be, independently of the nature of the solvent in which the particles may be placed at the time when the method belonging to the invention is initiated. It is thus compatible with all solution of colloids/of particles, even those exhibiting non-spherical shapes.

Overall the invention greatly improves the reliability of the operation for introducing particles at the surface of the carrier liquid.

Moreover, it is preferentially carried out such that the support floats in the carrier liquid. This technique allows the particles released to be brought as close as possible to the surface of the carrier liquid, upon which they must be ordered before being deposited on a substrate. As a result of the gradual melting/fusion of the support, gradual dispensation of the particles is achieved.

Furthermore, it should be noted that the solidified support initially exhibits a sub-zero temperature. As a result of the temperature gradient and the phase change during melting, the fluid is not at rest, in particular as a result of the descent of the cold fluid. The liquid motion thus promotes agitation of the surface which favours the dispersion of the particles.

Finally, it should be noted that the local drop in temperature results in an increase of the surface tension of the carrier liquid located close to the frozen material. This effect is beneficial since it plays a part in keeping the particles at the surface of the carrier liquid, that is, at the gas/liquid interface.

Furthermore, the invention also exhibits at least one of the following optional characteristics, taken in isolation or in combination.

Said particles are preferably non-spherical in shape, and preferably of any whatsoever of the forms stated earlier. Nevertheless, the invention remains applicable to particles of any shape and character whatsoever.

Said particles are preferably of micrometric or nanometric size, and preferably have a largest dimension of between 1 nm and 500 μm. By way of illustrative examples, the particles/colloids used may be a type of oxide particle (SiO2, ZnO, Al2O3, etc.), polymers (latex, PMMA, polystyrene, etc.) or metallic particles (Au, Cu, alloys, etc.). They may also be particles composed of several materials: polymer/metal, oxide/metal, oxide/polymer, metal/oxide/polymer, or Janus particles.

Even though the range of particle dimensions is preferably between 1 nm and 500 μm, it is also possible to use glass fibres or the other fibres referred to earlier, for example of diameter between 0.01 and 10 μm, and of lengths from 10 to 4000 μm.

Other particles of the silicon or graphene sheet or hBN sheet types may also be envisaged without going beyond the scope of the invention.

The carrier liquid is preferably deionised water.

Said solidified part of the support wherein the particles are trapped is preferably made from at least water. More generally the solidified part is preferably made from an aqueous-base liquid, for example water containing additives. This promotes floatation of the support, the advantages of which have been stated above.

Said solidified part of the support, wherein the particles are trapped, is preferably also made from a solvent wherein said particles were initially present, in suspension.

The presence of the solvent, in solidified form or simply in liquid film state on the solidified portion made from water proves to be advantageous. In effect, due to the difference in surface tension between the water and the solvent, the interfacial tension gradient induces hydrodynamic instabilities the consequences of which are local agitation of the two liquids. This agitation effect, known as the Marangoni effect, promotes dispersion of the particles at the surface of the carrier liquid.

As stated above, the step of setting up of said one or more particle supports is preferably carried out in such a way that this support floats on the surface of said carrier liquid. Yet more preferably, the particles are grouped together on one loaded surface of the support, and the step for setting up said one or more particle supports is achieved in such a way that said loaded face of the support is substantially at the carrier liquid surface. This facilitates yet further the dispersion of the particles over the surface of the carrier liquid.

The method preferably comprises a prior step for the fabrication of said one or more supports wherein said particles are trapped. This fabrication may be implemented in accordance with several techniques.

According to a first fabrication technique said fabrication of said support, wherein said particles are trapped, comprises the following operations:

a) introduction of a quantity of water into a container containing a solvent that is immiscible with water and whose density is less than that of water, with said particles arranged in suspension in said solvent, so that the particles migrate to the interface between the water and the solvent, possibly assisted by stirring;

b) cooling so as to obtain said support comprising at least one solidified part wherein said particles are trapped.

Preferably an operation for extraction of all or part of the solvent is implemented between operations a) and b). Alternatively, the cooling operation also aims to completely or partially solidify said solvent introduced into the container.

According to a second technique, said fabrication of said support wherein said particles are trapped comprises an operation for the formation of a block of solidified water. The fabrication then comprises an operation involving pouring a solvent wherein said particles are arranged in suspension onto the block of solidified water. Instead of pouring it, the solvent may be dispensed, projected or applied by spray.

The assembly may then be used as it is or this assembly formed by the block of solidified water and the solvent incorporating particles is cooled so that said solidified part of the support comprises at least a part of said solvent, and preferably all of it.

According to yet another alternative for this second technique, said fabrication of said support wherein said particles are trapped then comprises an operation involving directly pouring said particles in powder state onto the block of solidified water.

According to a third fabrication technique said fabrication of said support, wherein said particles are trapped, comprises the following operations:

a) introduction of the particles into the bottom of a container;

b) introduction of water into the container so as to keep the particles in the bottom of the container;

c) cooling so as to obtain said support comprising at least one solidified part wherein said particles are trapped.

Another object of the invention is a method for the deposition of a compact film of particles onto a substrate, comprising the use of the method for the formation of a compact film of particles at the surface of a carrier liquid, followed by a step for the deposition of the compact film of particles on a substrate.

Preferably said step for deposition of the compact film of particles in implemented on a moving substrate, that is, with the film being gradually deposited on a substrate in motion. Alternatively, the deposition of all the particles of the film onto the substrate can be carried out simultaneously, for example by bringing the film close to the substrate, from above or below, in the manner of the Langmuir-Schaefer technique.

Other advantages and characteristics of the invention will appear in the non-restrictive detailed disclosure below.

### BRIEF DESCRIPTION OF THE DRAWINGS

This description will be made in relation to the appended drawings, wherein:

FIG. 1 shows an installation for implementation of the method according to the invention, in longitudinal section;

FIG. 2 shows a top schematic view of the installation shown in FIG. 1;

FIGS. 2a to 5b schematically show the various steps of a method for formation and for deposition of a compact film of particles according to one preferred embodiment of the inventions, implemented using the installation shown in the preceding figures; and

FIGS. 6 to 8 show different possibilities for fabrication of the particles support implemented in the method shown schematically in FIGS. 2a to 5b.

### DETAILED DESCRIPTION OF PREFERRED EMBODIMENTS

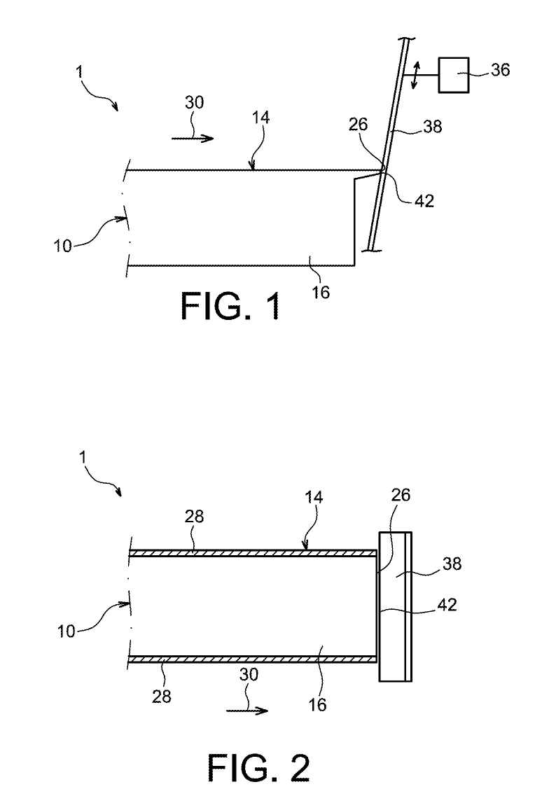

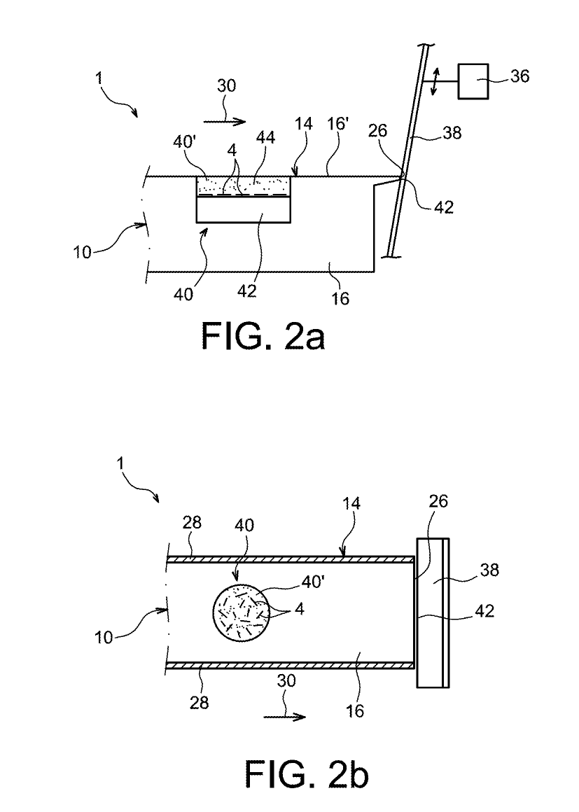

With reference first of all to FIGS. 1 et 2, an installation 1 is shown for the formation of a compact film of particles and for its transfer onto a substrate which is preferably moving. The particles concerned, not shown in FIGS. 1 and 2, are envisaged as being initially placed in suspension in a solvent. These particles have a size which may be between a few nanometres and several hundred micrometres. The particles or colloids are preferably non-spherical in shape. They may take longilinear forms such as fibres, threads, tubes or rods or more complex forms such as polygons, tetrapods, cubes, prisms, polygons etc. For the purposes of simplification of the following figures, the particles are shown in them as simple tubes with dimensions greater than the actual dimensions.

The materials that may be envisaged for these particles will depend on the desired applications. They may be, for example, particles of silica, of glass fibre, carbon nanotube particles or particles of gallium nitride fibres. Other particles of interest may be made of metal or of metal oxide such as Platinum, TiO2, of polymers such as polystyrene or PMMA, of carbon fibres etc., or particles made up of several materials. More precisely, in the preferred embodiment the particles are made of glass fibre of diameter of the order of 10 μm, and whose length is of the order of 4 mm. It should be noted that the invention applies in particular to thread-like elements whose largest dimension is more than ten times greater than the smallest dimension. As will be described in detail below, the particles are intended to be placed in suspension in a solvent, here of a type such as butanol or chloroform, where the proportion of the medium is about 7 g of particles per 200 ml of solvent.

The installation also comprises a liquid conveyor 10 which receives a carrier liquid 16 upon which the particles are intended to float. The carrier liquid 16 is preferably deionised water. The conveyor 10 incorporates a zone 14 for the accumulation and transfer of the particles, whose bottom is essentially horizontal, or slightly inclined in order to favour drainage from the installation if necessary.

The zone 14 exhibits an outlet for the particles 26, defined using two lateral ledges 28 which retain the carrier liquid 16 in the zone 14. These edges 28, facing each other and set a distance apart, extend parallel to a principal direction represented schematically by the arrow 30 in FIGS. 1 and 2. This direction 30 corresponds to that of the movement of the compact film of particles during its transfer onto the substrate, as will be described in detail hereafter.

The bottom of the downstream part of the zone 14 has a plateau which is slightly inclined towards the upstream direction relative to the horizontal direction, for example with a value of the order of 5 to 10°. The downstream extremity of this same plateau, also known as the “blade” partially defines the outlet for the particles 26.

The installation 1 is also provided with a substrate conveyor 36 intended to set the substrate 38 in motion. This substrate may be rigid or flexible. In this last case, which is not shown, it may be set in motion on a roller whose axis is parallel to the outlet 26 from the zone 14 close to which it is located.

Irrespective of the envisaged configuration, the substrate 38 is intended to move in such a way that it is very close to the outlet 26, in order that the particles reaching this outlet can be easily transferred onto this substrate, via a capillary bridge 42, also known as a meniscus, which links it to the carrier liquid 16. The capillary bridge 42 is achieved between the carrier liquid 16 which is located at the outlet 26, and a part of the substrate 38 which fits against the guide/drive roller 40. Alternatively, the substrate can be in direct contact with the transfer zone, without going beyond the scope of the invention. The capillary bridge mentioned above is no longer required.

For information, in the case of the substrate being rigid and the objects to be transferred also being rigid and being unable to adapt to an angular break during transfer, it may be advantageous to immerse the substrate in the liquid of the accumulation and transfer zone 14 and to carry out the withdrawal in this configuration. This will maximise the angle formed between the horizontal plane of the liquid of the zone 14 and the plane of the substrate.

In the example shown in the figures, the width of the substrate 38 is slightly greater than the width of the zone 14 and of its outlet 26. The width of the zone 14 also corresponds to the maximum width of the film of particles that can be deposited on the substrate 38. This width may be of the order of 25 to 30 cm. The width of the substrate over which the particles must be deposited may however be less than the width of the zone 14, without going beyond the scope of the invention.

A method for formation and for deposition of a compact film of particles according to a preferred embodiment of the invention will now be described with reference to FIGS. 2a to 5b.

First of all with reference to FIGS. 2a and 2b, a support 40 for the particles in said carrier liquid 16 is set up. Initially this support 40 comprising at least one solidified portion in which the particles 4 are trapped, where this solidified part is made from at least one frozen liquid. Preferably, before it is introduced into the carrier liquid 16 the support is completely solidified, and comprises a lower part 42 which corresponds to frozen pure water together with an upper part 44 which corresponds to the solidified solvent. Alternatively, the solvent may take the form of a liquid film resting on pure frozen water. Whichever is the case, the particles 4 are trapped at the interface between the upper part 44 and lower part 42. Details of the fabrication of the support 40 will be given later.

The support 40, in its initial state has, for example, a cylindrical form with a circular cross-section, with a thickness of about 5 mm and a diameter of 40 mm. Greater dimensions may be chosen however without going beyond the scope of the invention. The particles 4 are grouped together at a loaded face of the support, which corresponds to the upper surface 40′, which is substantially flat and aligned horizontally.

Because of its composition essentially based on frozen water, the support 40 floats when it is introduced into the carrier liquid 16. This introduction is achieved in such a way that the charged face 40′ of the support 40 is substantially at the level of the surface 16′ of the carrier liquid 16, or close to the latter. This aim is easily achieved when the thickness of the solidified solvent 44 is small. Nevertheless, the solvent may not be entirely solidified, but made to be in a viscous state, for example.

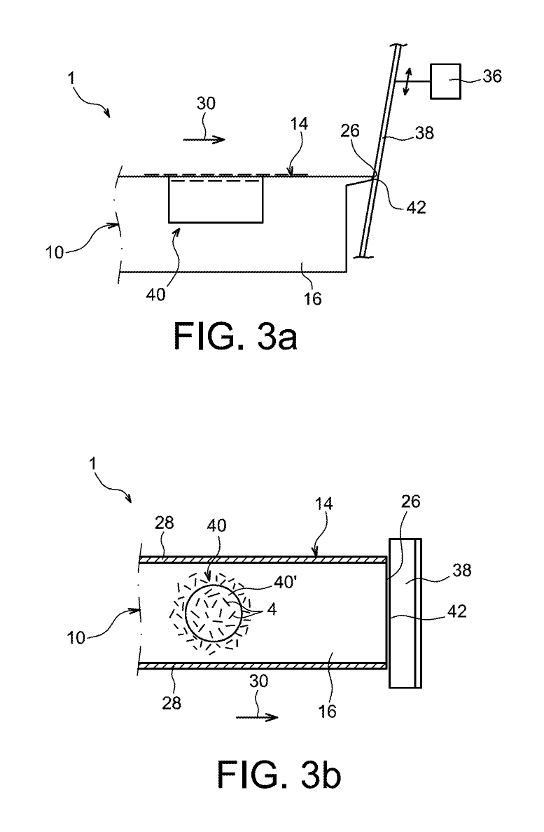

Once introduced into the carrier liquid 16, the support 40 undergoes fusion and gradually melts, releasing the particles 4 which may then be dispersed, also gradually, at the surface of the carrier liquid 16, as has been shown schematically in FIGS. 3a and 3b.

As a result of the temperature gradient and the phase change during melting of the support 40, the fluid is not at rest, in particular as a result of the descent of the cold fluid. The liquid motion within the zone 14 thus promotes agitation of the surface which favours the dispersion of the particles 4. Furthermore, the local drop in temperature results in an increase of the surface tension of the carrier liquid 16 located close to block of frozen material 40. This effect is beneficial since it helps to keep the particles 4 at the surface 16′ of the carrier liquid 16. Moreover, due to the difference in surface tension between the water and the solvent as fusion occurs, the interfacial tension gradient induces hydrodynamic instabilities which thus contribute to local agitation of the two liquids, favouring the dispersion of the particles at the surface 16′ of the carrier liquid.

It should be noted that several supports 40 may be introduced successively or simultaneously into the carrier liquid in order to increase the quantity of the required particles. A pumping system (not shown) can in addition regulate the total volume of the liquid in the zone 14, taking into consideration the additional water added by the supports 40 introduced into this zone.

When the total amount of particles 4 are present at the surface 16′ in the accumulation and transfer zone 14, they are pushed in the direction of the outlet 26 by a barrier 50 or a similar element. This barrier 50 is in effect moved along the direction 30 so that the particles 4 are ordered by being retained upstream by the substrate 38 forming an end stop.

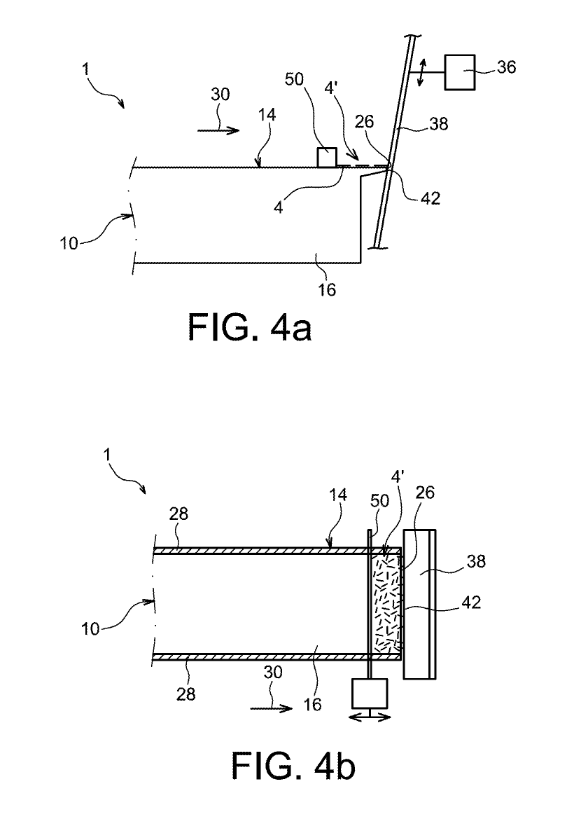

This ordering by means of the barrier 50 and the substrate 38 generates a compact film 4′ of particles 4, as has been shown schematically in FIGS. 4a and 4b.

Alternatively, it is possible to set up a ramp conveyor as described earlier, in which the particles are automatically ordered, without assistance, in particular because of their kinetic energy and use made of the capillary forces at the moment of impact onto the leading edge of the particles present on the ramp. In this instance, the supports 40 are then preferably placed in the reservoir of the conveyor, upstream of the ramp.

Other means of ordering known to those skilled in the art may also be envisaged without going beyond the scope of the invention.

The ordering desired is such that the compact film obtained exhibits a structure that is similar to a “compact hexagonal” structure in the case of spheres, wherein each particle 4 is surrounded by and in contact with six other particles 4 which are in contact with each other. This may be referred to either as a compact film of particles or equally as a film of ordered particles.

Once the film 4′ has been obtained at the surface of the carrier liquid 16 in the zone 14, a step involving structuring of this film may be carried out, details of which will not be given here, but which is known to those skilled in the art. This involves, for example, placing objects on the compact film.

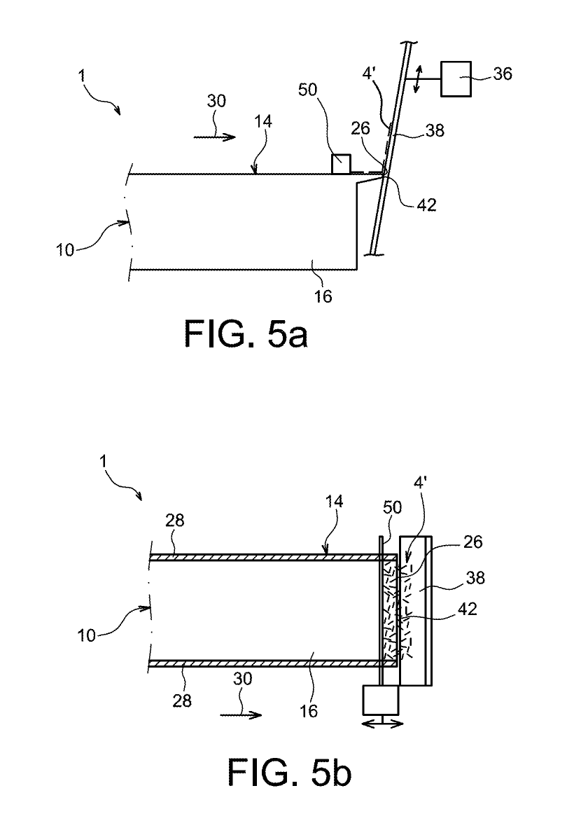

Then the substrate 38 is set in motion at the same time as the barrier 50 continues to undergo displacement downstream, so as to gradually deposit the film 4′ on this substrate 38 via the capillary bridge 42. This step of deposition of the film 4′, also known as the transfer step, has been shown schematically in FIGS. 5a and 5b. In effect, when the substrate 38 starts to move past, the film 4′ is deposited on it by passing through the outlet 26 and over the capillary bridge 42, in the manner described in document CA 2 695 449. A solution using direct contact rather than a capillary bridge can also be envisaged without going beyond the scope of the invention.

In order to facilitate the deposition and the adhesion of particles 4 onto the substrate 38 made, for example, of polymer, thermal annealing subsequent to the transfer may be envisaged. This thermal annealing may be carried out, for example, at 80° C., using a polyester-based low temperature mat lamination film, for example that sold under the name PERFEX-MATT™, with a thickness of 125 μm. The advantage of such a film as a substrate is that one of its faces becomes adhesive at temperatures of the order of 80° C. This facilitates the adhesion of the particles 4 onto the film. More specifically, at this temperature the particles 4 sink into the softened film 38, enabling direct contact to be made with the film, which leads to adhesion of the particles.

Alternatively, the substrate 38 may be of the silicon, glass or even piezoelectric film type.

During transfer the linear velocity of the substrate 38, also known as the draw speed, may be of the order of 0.1 cm/min to 100 cm/min.

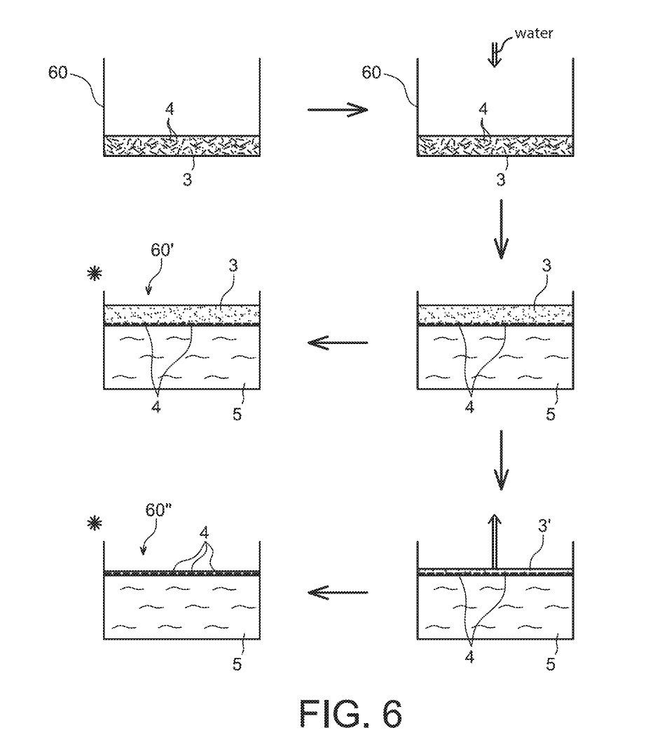

With reference now to FIG. 6, a first technique for fabrication of the support 40 is shown.

First of all, a container 60 is envisaged in which the solvent 3 incorporating the particles 4 in suspension is arranged. A given quantity of pure water is then introduced into the container 60. The solvent 3, butanol, is immiscible with water and has a density which is less than that of water. Thus, after the pure water is introduced, the particles 4 migrate so that they are arranged in a horizontal plane at the interface between the water 5 located above and the solvent located below. The migration can be encouraged by stirring in the container.

According to a first possibility, the assembly 60′ is then cooled directly in order to obtain the aforementioned support 40. The cooling temperature is therefore preferably below the melting point of the solvent, so that the solidified part of the support incorporates both the pure water and the solvent, with the particles trapped at the interface.

According to another possibility, an operation for extraction of the solvent is carried out such that only a very thin layer is retained above the water, or this solvent is even removed altogether. The assembly 60″ is then frozen, in order to obtain the support 40 whose solidified part made of pure water incorporates the particles 4. Any film 3′ of solvent that remains can be kept in the liquid state at a low temperature before the support 40 is introduced into the carrier liquid, or can also be solidified if the cooling temperature is sufficiently low.

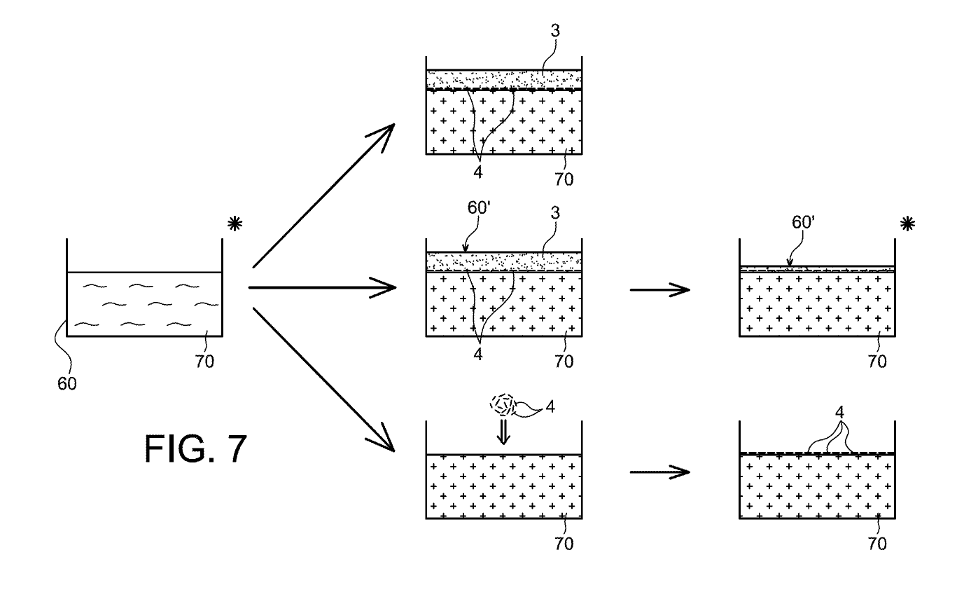

According to a second technique for fabrication of the support 40 shown schematically in FIG. 7, an operation for the formation of a block of solidified pure water 70 in a container 60 is first of all carried out. Then an operation is carried out involving pouring a solvent 3, in which the particles 4 are in suspension, into the container 60, over the block of solidified water 70. This leads to the particles 4 migrating to the interface between the solvent 3 and the block of solidified water 70, so that they are trapped at the upper surface of the latter. Moving the particles to the interface can also be achieved by decantation. Then the surplus solvent is also preferably withdrawn, so that only a very thin layer of solvent remains, with the particles arranged at the interface between this layer and the ice. Removal of the solvent can be achieved by pipetting or by flowing under gravity.

The assembly then forms the support 40 which can then be introduced as it is into the carrier liquid.

According to another possibility, the assembly 60′ obtained can be cooled below the melting temperature of the solvent 3 so that the entire support 40 is solidified before it is introduced into the carrier liquid.

According to yet another possibility, after the block of solidified water 70 is obtained, an operation may be carried out involving pouring particles 4 in a powder state directly onto the upper surface of the block 70. These particles 4, when they come into contact with the upper surface of the block 70 are trapped by the latter.

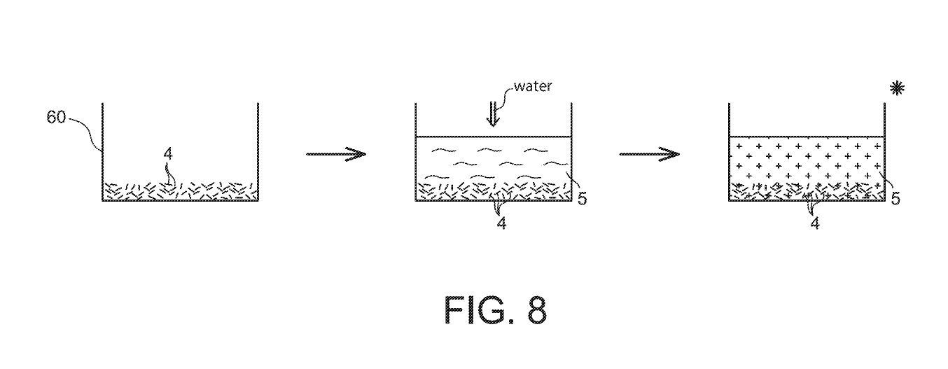

Finally, with reference to FIG. 8, a third technique is shown schematically for fabrication of the support 40, which involves first of all introducing particles 4 into the bottom of a container 60. Then water 5 is poured into the container 60 so as to keep the particles 4 in the bottom of the container, by keeping the flow of water being poured low. To complete the process the assembly is cooled and solidified in order to obtain the support 40. The solidified part of the latter is then made up of a block of water wherein the particles 4 are trapped on the lower surface. When this support is introduced into the carrier liquid, it is preferably turned over so that the surface loaded with particles forms the upper surface of the support 40.

Naturally those skilled in the art may make various modifications to the invention which has just been described, solely as non-restrictive examples.

1-19. (canceled)

20. A method for formation of a compact film of particles at a surface of a carrier liquid comprising:
setting up at least one support for the particles in the carrier liquid, wherein the support includes at least one solidified portion wherein the particles are trapped and which is made from at least one cooled liquid, wherein the support melting into the carrier liquid leads to particles being released at the surface of this carrier liquid; and
ordering the particles released to obtain the compact film of particles at the surface of the carrier liquid.

21. A method according to claim 20, wherein the particles are non-spherical in shape.

22. A method according to claim 20, wherein the particles are micrometric or nanometric size, and have a largest dimension of between 1 nm and 500 μm.

23. A method according to claim 20, wherein the carrier liquid is deionized water.

24. A method according to claim 20, wherein the solidified part of the support, wherein the particles are trapped, includes water.

25. A method according to claim 24, wherein the solidified part of the support, wherein the particles are trapped, further includes a solvent wherein the particles were initially present, in suspension.

26. A method according to claim 20, wherein the setting up the one or more particle support is carried such that the support floats on the surface of the carrier liquid.

27. A method according to claim 26, wherein the particles are grouped together at one loaded surface of the support, and the setting up the one or more particle supports is achieved such that the loaded face of the support is substantially at the carrier liquid surface level.

28. A method according to claim 20, further comprising a prior fabrication of the one or more support wherein the particles are trapped.

29. A method according to claim 28, wherein the fabrication of the support wherein the particles are trapped comprises:
a) introducing a quantity of water into a container containing a solvent that is immiscible with water and whose density is less than that of water, with the particles arranged in suspension in the solvent, so that the particles migrate to an interface between the water and the solvent;
b) cooling to obtain the support comprising at least one solidified part wherein the particles are trapped.

30. A method according to claim 29, further comprising extracting all or part of the solvent between a) and b).

31. A method according to claim 29, wherein the cooling operation completely or partially solidifies the solvent introduced into the container.

32. A method according to claim 28, wherein the fabrication of the support wherein the particles are trapped comprises formation of a block of solidified water.

33. A method according to claim 32, wherein the fabrication of the support wherein the particles are trapped further comprises pouring a solvent in which the particles are arranged in suspension, onto the block of solidified water.

34. A method according to claim 33, wherein an assembly formed by the block of solidified water and the solvent incorporating the particles is cooled such that the solidified part of the support comprises at least a part of the solvent.

35. A method according to claim 32, wherein the fabrication of the support wherein the particles are trapped further comprises pouring the particles in powder form directly onto the block of solidified water.

36. A method according to claim 28, wherein the fabrication of the support wherein the particles are trapped comprises:
a) introducing the particles into a bottom of a container:
b) introducing water into the container to keep the particles in the bottom of the container;
c) cooling to obtain the support comprising at least one solidified part wherein the particles are trapped.

37. A method for deposition of a compact film of particles onto a substrate, comprising use of the method for formation of a compact film of particles at the surface of a carrier liquid according to claim 20, followed by deposition of the compact film of particles on a substrate.

38. A method for deposition according to claim 37, wherein the deposition of the compact film of particles implemented on a moving substrate.
